(19) United States
(12) Patent Application Publication
(10) Pub. No.: US 2026/0291825 A1
(43) Pub. Date: Sep. 24, 2026

(54) METHOD AND APPARATUS FOR GENERATIVE MODEL BASED INTEROPERABILITY

(71) Applicant: InterDigital Patent Holdings, Inc., Wilmington, DE (US)

(72) Inventors: Aditya Sant, San Jose, CA (US); Yugeswar Deenoo Narayanan Thangaraj, Chalfont, PA (US); Akshay Malhotra, San Jose, CA (US); Mihaela Beluri, Jericho, NY (US)

(73) Assignee: InterDigital Patent Holdings, Inc., Wilmington, DE (US)

(21) Appl. No.: 19/088,206

(22) Filed: Mar. 24, 2025

(51) Int. Cl. H04L 41/16; H04W 24/02; H04W 28/02

(52) U.S. Cl. CPC H04L 41/16; H04W 24/02; H04W 28/0215

(57) ABSTRACT

A wireless transmit/receive unit (WTRU) is configured to operate to receive from a network (NW), a first artificial intelligence or machine learning (AI/ML) model via broadcast signaling and a second AI/ML model via dedicated signaling. The WTRU generates a third AI/ML model using the first AI/ML model and the second AI/ML model and generates a plurality of data samples using the third AI/ML model based on a data generation configuration. The WTRU sends an interoperability report to the NW, wherein the interoperability report is based on the plurality of data samples generated using the third AI/ML model and an output of a fourth AI/ML model. The fourth AI/ML model is generated using one or more of the second AI/ML model, the third AI/ML model and data from the third AI/ML model.

### BACKGROUND

Channel State Information, which may include at least one of the following: channel quality index (CQI), rank indicator (RI), precoding matrix index (PMI), an L1 channel measurement (e.g., the Reference Signal Received Power (RSRP), such as L1-RSRP, or Signal-to-Interference-plus-Noise Ratio (SINR)), channel state information reference signal (CSI-RS) resource indicator (CRI), synchronization signal/physical broadcast channel (SS/PBCH) block resource indicator (SSBRI), layer indicator (LI) and/or any other measurement quantity measured by a wireless transmit receive unit (WTRU) from the configured reference signals (e.g. CSI-RS or SS/PBCH block or any other reference signal).

A WTRU may be configured to report the channel state information (CSI) through the uplink control channel on the physical uplink control channel (PUCCH), or per the request from the Next Generation Node B (gNB) on an uplink (UL) Physical Uplink Shared Channel (PUSCH) grant. Depending on the configuration, CSI-RS can cover the full bandwidth of a Bandwidth Part (BWP) or just a fraction of it. Within the CSI-RS bandwidth, CSI-RS can be configured in each PRB or every other PRB. In the time domain, CSI-RS resources can be configured either periodic, semi-persistent, or aperiodic. Semi-persistent CSI-RS is similar to periodic CSI-RS, except that the resource can be (de)-activated by Medium Access Control (MAC) control elements (CEs); and the WTRU reports related measurements only when the resource is activated. For Aperiodic CSI-RS, the WTRU is triggered to report measured CSI-RS on PUSCH by request in a DCI. Periodic reports are carried over the PUCCH, while semi-persistent reports can be carried either on PUCCH or PUSCH. The reported CSI may be used by the scheduler when allocating optimal resource blocks possibly based on channel's time-frequency selectivity, determining precoding matrices, beams, transmission mode and selecting suitable MCSs. The reliability, accuracy, and timeliness of WTRU CSI reports may be critical to meeting ultra-reliable low latency (URLLC) service requirements.

Considering the option of artificial intelligence (AI) or machine learning (ML), or the like, two-sided model training may be a challenging task for training CSI compression models, for example autoencoders. This is specifically due to the fact the encoder and decoder are trained by different vendors. However, efficient training of two-sided models for different tasks like inter-vendor CSI compression and recovery requires dataset consistency across the network (NW) and WTRU nodes. This specifically runs into the following constraints: (i) sharing both models and datasets from NW to WTRU, or vice versa, encounters large overhead during signaling, (ii) the overhead is further increased due to sharing of multiple datasets for multiple scenarios in the wireless channel, and (iii) open access, or offline sharing, of datasets and NWs runs into risk of unauthorized access by unintended WTRU or NW vendors. Thus, there is a need of a framework to perform efficient dataset exchange between the WTRU and NW nodes, without compromising the security of publicly shared data or models. Additionally, mechanisms may be needed to ensure that AI/ML models operate in conditions consistent with the data samples used for training.

### SUMMARY

In embodiments, as a method of operation or by the processor configuration, a WTRU may receive from a network (NW) a first AI/ML model, preferably by a broadcast signaling process. The first AI/ML model may be a generative model The WTRU further receives from the NW a second AI/ML model by dedicated signaling, although other secure download procedure may be utilized in whole or in part. The WTRU may send the identity of the received first AI model to the NW, and the NW may respond by sending the second AI/ML model that corresponds to the first AI/ML model. The WTRU derives a third AI/ML model using the first AI/ML model and the second AI/ML model. The WTRU may further receive a data generation configuration. The WTRU generates a plurality of data samples using the third AI/ML model based on the data generation configuration and sends an interoperability report to the NW, wherein the interoperability report is based on the plurality of data samples generated using the third AI/ML model and an output of a fourth AI/ML model.

In embodiments, the fourth AI/ML model is generated by the WTRU using one or more of the second AI/ML model, the third AI/ML model and data from the third AI/ML model. The second AI/ML model may be configured to generate the fourth AI/ML model so as to be compatible with an AI/ML model operating at the NW, and configured to generate data samples. In embodiments, the WTRU may generate the fourth AI/ML model using data generated by the third AI/ML model, and wherein the output of the fourth AI/ML model may include a compressed version of the plurality of data samples generated using the third AI/ML model.

The WTRU may be further configured to send one or more of the output of the fourth AI/ML model and a performance metric associated with the fourth AI/ML model. The WTRU may generate samples of channel matrices from a predefined channel distribution. The distribution may include channels created using one or more of a predefined statistics, field measurements, and synthetic data. The WTRU may derive the third AI/ML model using the first AI/ML model and the subnetwork generated using the second AI/ML model. The subnetwork includes at least a portion of layers of the second AI/ML model or may include parameters associated with a distribution configuration associated with the first AI/ML model.

The WTRU may further generate a plurality of data samples using the third AI/ML model based on a set of data samples determined from one or more of a preconfigured distribution, current measurements, and historical measurement data.

### BRIEF DESCRIPTION OF THE DRAWINGS

FIG. 1A is a system diagram illustrating an example communications system in which one or more disclosed embodiments may be implemented.

FIG. 1B is a system diagram illustrating an example WTRU that may be used within the communications system illustrated in FIG. 1A according to an embodiment.

FIG. 1C is a system diagram illustrating an example radio access NW (Radio Access Network (RAN) and an example core NW (CN) that may be used within the communications system illustrated in FIG. 1A according to an embodiment

FIG. 1D is a system diagram illustrating a further example RAN and a further example for Core Network (CN) that may be used within the communications system illustrated in FIG. 1A according to an embodiment.

FIG. 2 is a block diagram showing an embodiment for training a WTRU-sided AI/ML model and for generating data for training, evaluation and performance monitoring.

### DETAILED DESCRIPTION

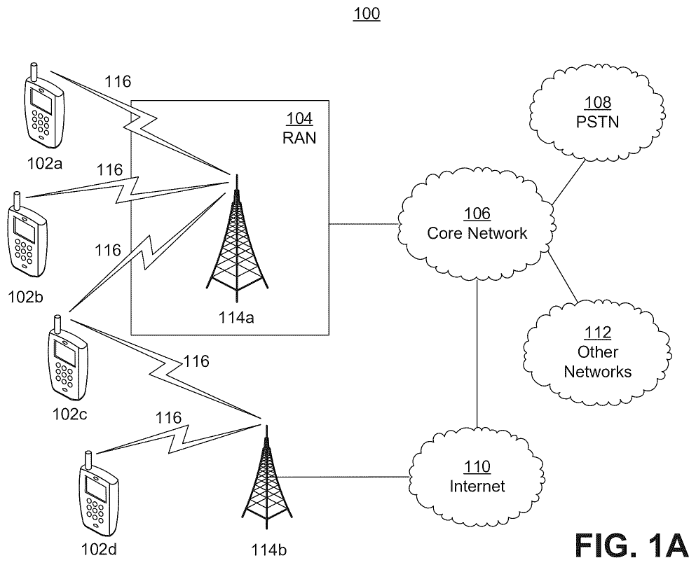

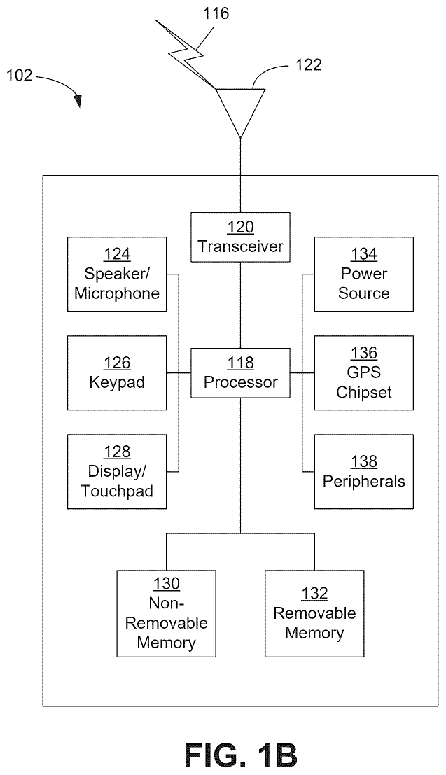

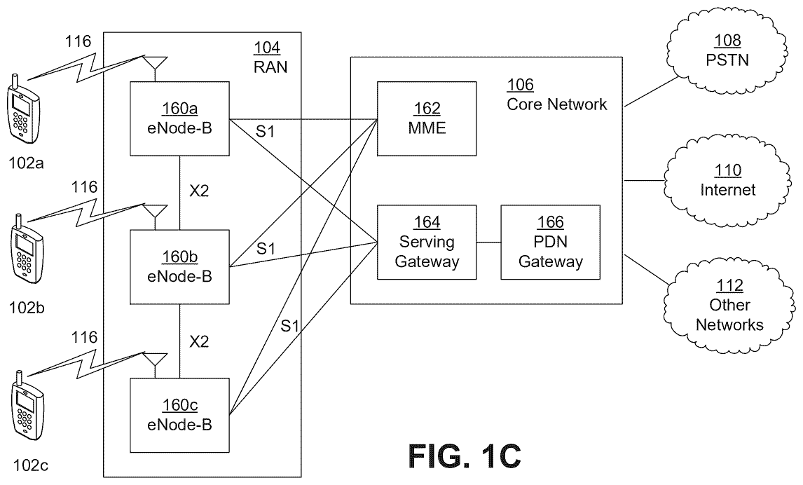

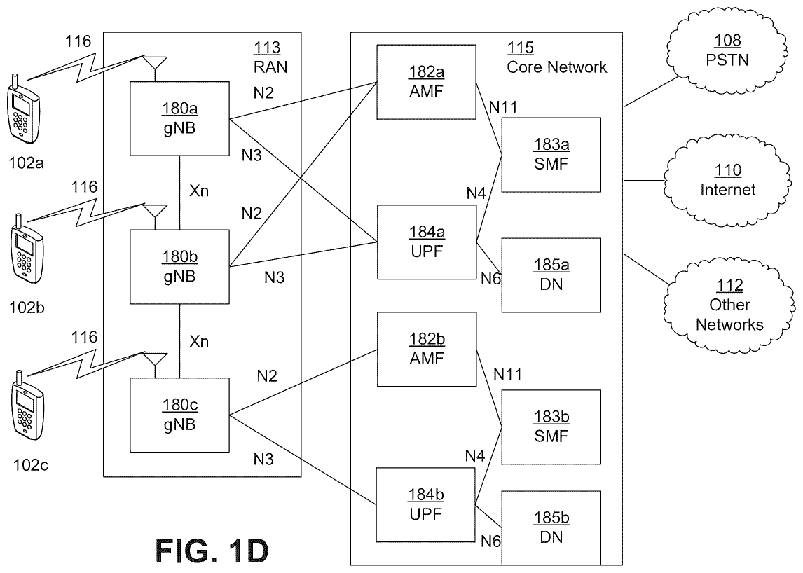

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone NW (PSTN) 108, the Internet 110, and other NWs 112, though it will be appreciated that the disclosed embodiments contemplate any number of WTRUs, base stations, NWs, and/or NW elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless NWs, and the like. Any of the WTRUs 102a, 102b, 102c and 102d may be interchangeably referred to as a WTRU. Further, any description herein that is described with reference to a WTRU may be equally applicable to a WTRU (or vice versa). For example, a WTRU may be configured to perform any of the processes or procedures described herein as being performed by a WTRU (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication NWs, such as the CN 106/115, the Internet 110, and/or the other NWs 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or NW elements.

The base station 114a may be part of the RAN 104/113, which may also include other base stations and/or NW elements (not shown), such as a base station controller (BSC), a radio NW controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area NW (WLAN). In an embodiment, the base station 114b and the WTRUs 102c, 102d may implement a radio technology such as IEEE 802.15 to establish a wireless personal area NW (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of NW configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other NWs 112. The PSTN 108 may include circuit-switched telephone NWs that provide plain old telephone service (POTS). The Internet 110 may include a global system of interconnected computer NWs and devices that use common communication protocols, such as the transmission control protocol (TCP), user datagram protocol (UDP) and/or the internet protocol (IP) in the TCP/IP internet protocol suite. The NWs 112 may include wired and/or wireless communications NWs owned and/or operated by other service providers. For example, the NWs 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless NWs over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data NW (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched NWs, such as the Internet 110, to facilitate communications between the WTRUs 102a, 102b, 102c and IP-enabled devices.

The CN 106 may facilitate communications with other NWs. For example, the CN 106 may provide the WTRUs 102a, 102b, 102c with access to circuit-switched NWs, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other NWs 112, which may include other wired and/or wireless NWs that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication NW.

In representative embodiments, the other NW 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless NW that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the MAC.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of NW slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for NW slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different NW slices may be established for different use cases such as services relying on URLLC access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched NWs, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other NWs. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other NWs 112, which may include other wired and/or wireless NWs that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate NW and/or WTRU functions.

The emulation devices may be designed to implement one or more tests of other devices in a lab environment and/or in an operator NW environment. For example, the one or more emulation devices may perform the one or more, or all, functions while being fully or partially implemented and/or deployed as part of a wired and/or wireless communication NW in order to test other devices within the communication NW. The one or more emulation devices may perform the one or more, or all, functions while being temporarily implemented/deployed as part of a wired and/or wireless communication NW. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication NW. For example, the emulation devices may be utilized in a testing scenario in a testing laboratory and/or a non-deployed (e.g., testing) wired and/or wireless communication NW in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As discussed above, the CSI may include at least one of CQI, RI, PMI, an L1 channel measurement (e.g., RSRP such as L1-RSRP, or SINR), CRI, SSBRI, and LI, along with any other measurement quantity measured from the CSI-RS, SS/PBCH block, and/or other reference signal.

In embodiments, a WTRU may be configured to report the CSI through the uplink control channel on PUCCH, or per the gNBs' request on an UL PUSCH grant. Depending on the configuration, CSI-RS may cover the full bandwidth of a BWP or just a fraction of it. Within the CSI-RS bandwidth, CSI-RS may be configured in each Physical Resource Block (PRB), or every other PRB. In the time domain, CSI-RS resources may be configured either periodic, semi-persistent, or aperiodic. Semi-persistent CSI-RS is typically considered similar to periodic CSI-RS, except that the resource can be (de)-activated by MAC CE and further that the WTRU reports related measurements only when the resource is activated. For Aperiodic CSI-RS, the WTRU may be triggered to report measured CSI-RS on PUSCH by request in a DCI. Periodic reports may be carried over the PUCCH, while semi-persistent reports can be carried either on PUCCH or PUSCH. The reported CSI may be used by the scheduler when allocating optimal resource blocks possibly based on channel's time-frequency selectivity, determining precoding matrices, beams, transmission mode and selecting suitable MCSs.

Artificial intelligence may be broadly defined as the behavior exhibited by machines. Such behavior may e.g., mimic cognitive functions to sense, reason, adapt and act. The terms Artificial Intelligence (AI), Machine Learning (ML), Deep Learning (DL), Depp Neural Networks (DNNs) may be used interchangeably. For simplification purposes, the term AI/ML is used herein, unless a specific distinction is identified. Methods described herein are exemplified based on learning in wireless communication systems. The methods are not limited to such scenarios, systems and services and may be applicable to any type of transmissions, communication systems and/or services etc.

Auto-encoders (AE) are specific class of deep DNNs that arise in context of un-supervised machine learning setting wherein the high-dimensional data is non-linearly transformed to a lower dimensional latent vector using the DNN based encoder and the lower dimensional latent vector is then used to re-produce the high-dimensional data using a non-linear decoder. The encoder is represented as E(x; Wₑ) where x is the high-dimensional data and Wₑ represents the parameters of the encoder. The decoder is represented as D(z; W_{d}) where z is the low-dimensional latent representation and W_{d} represents the parameters of the decoder. Further, using training data {x₁, . . . , x_{N}} the auto-encoder can be trained by solving the following optimization equation:

$$\{ {W}_{e}^{tr} , {W}_{d}^{tr} \} = arg {min}_{{W}_{e} , {W}_{d}} {\sum }_{i = 1}^{N} {‖ {x}_{i} - D ( E ( {x}_{i} ; {W}_{e} ) ; {W}_{d} ) ‖}_{2}^{2} . \qquad [ 1 ]$$

The above equation can be approximately solved using backpropagation algorithm. The trained encoder

$$E ( x ; {W}_{e}^{tr} )$$

can be used to compress the high-dimensional data and trained decoder

$$D ( z ; {W}_{d}^{tr} )$$

can be used to decompress the latent representation.

Generative models are a class of DNN models that learn the underlying distribution and features in the dataset, to enable these to create new samples within the same distribution. These models have been applied to various fields in image processing, text generation, as well as in wireless communication systems for applications like channel modeling. These models are trained to capture the distribution and features of the training set into a latent distribution by optimizing losses like the reconstruction loss, variational loss, etc. During inference, generative models take in input from a preconfigured distribution like the standard normal distribution and use it to generate realistic data samples. There are several classes of generative models, developed for various applications. Two specific models with applicability in this work are elaborated here. These are the (i) Variational autoencoders (VAEs) and (ii) Generative adversarial networks (GANs). These are detailed below.

The variational autoencoder consists of two parts, specifically the encoder and decoder model. The encoder maps the input to a latent space distribution, like a Gaussian distribution. The decoder reconstructs the data by drawing samples from this latent distribution. The training loss for the VAE consists of two specific additive components, (i) the reconstruction loss, for example, the mean square error (MSE) loss, that measures the sample recreation quality by the decoder, and (ii) the KL divergence loss that measures the difference between the learnt latent distribution and a prior preconfigured distribution, like a standard normal distribution. This may be defined by the following equation:

$${ℒ}_{VAE} = 𝔼 {‖ x - \hat{x} ‖}^{2} + λ {D}_{KL} ( q ( z \vert x ) \vert \vert p ( z ) ) , \qquad [ 2 ]$$

where, q(z|x) is the learnt latent distribution, p(z) is a preconfigured distribution like the Gaussian distribution, and λ is a regularizing factor.

Generative Adversarial Networks (GANs) also consist of two models, the generator and the discriminator. The generator creates data samples from an input preconfigured distribution like the standard normal distribution and the discriminator distinguishes between the real training data sample and the fake sample created by the generator. These models are trained in a minimax game that involves the generator creating samples to fool the discriminator and the discriminator striving to correctly identify the authentic sample. The training loss consists of the discriminator loss [symbol] _{D} and generator loss [symbol] _{G}, given by the following equations:

$${ℒ}_{D} = - {𝔼}_{x ∼ {p}_{data} ( x )} log D ( x ) - {𝔼}_{z ∼ {p}_{z} ( z )} log ( 1 - D ( G ( z ) ) ) \qquad [ 3 ]$$

$${ℒ}_{G} = {𝔼}_{z ∼ {p}_{z} ( z )} log ( 1 - D ( G ( z ) ) ) , \qquad [ 4 ]$$

where, q(z|x) is the learnt latent distribution, p(z) is a preconfigured distribution like the Gaussian distribution, and λ is a regularizing factor.

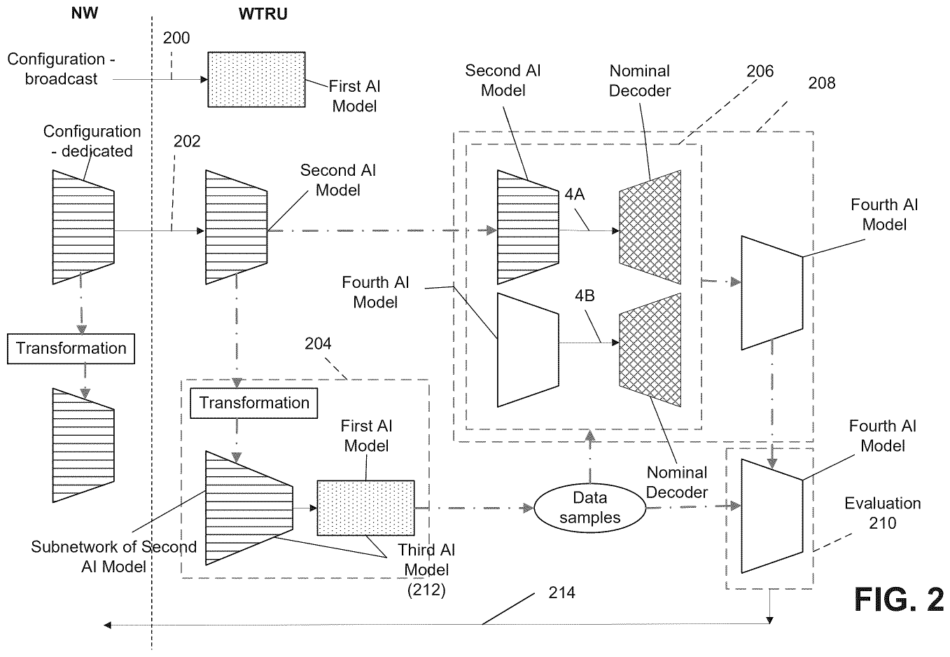

Two-sided model training may be challenging for training CSI compression AE models. This may be due at least the encoder and decoder normally being trained by different vendors. However, efficient training of two-sided models for different tasks, such as inter-vendor CSI compression and recovery, may require dataset consistency across the NW and WTRU nodes. Typically, one or more of the following constraints may be present: (i) sharing both models and datasets from NW to WTRU, or vice versa, encounters large overhead during signaling, (ii) the overhead is further increased due to sharing of multiple datasets for multiple scenarios in the wireless channel, and (iii) open access, or offline sharing, of datasets and NWs runs into risk of unauthorized access by unintended WTRU or NW vendors. Thus, it may be advantageous to provide a framework for efficient dataset exchange between the WTRU and NW nodes, without compromising security of publicly shared data or models. Additionally, mechanisms may be included to ensure that AI/ML models operate in conditions consistent with the data samples used for training. In embodiments, a WTRU may utilize an overloaded nominal encoder for dual purpose of training a WTRU-sided encoder and to generate data for such training/evaluation/performance monitoring. In FIG. 2 there is provided an overview of one example of a dual purpose training method.

The following is one method for the execution of this dual purpose training approach. In embodiments, a WTRU may be configured with a first AI/ML model, preferably via a broadcast signaling (e.g., SIB) from the NW. This step 1 is identified as 200 in FIG. 2. The first AI/ML model may be a generative model. For example, the first AI/ML model may be trained to generate samples of channel matrices, from a distribution of channels. The distribution may include channels created using one or more of a predefined statistics, field measurements, and synthetic data. In other embodiments, the WTRU may receive the first AI/ML model (architecture and/or parameters) via offline engineering, e.g., downloaded from an OTT server, from a NW/operator server etc. Still further, the first AI/ML model (or model architecture) may be a predefined model (e.g., in the standards).

As second step, the WTRU may be configured through the NW with a second AI/ML model, preferably via a dedicated signaling (e.g., RRC (re) configuration). The second AI/ML model may be an encoder model or a decoder model or encoder/decoder pair. In FIG. 2, this step 2 is identified by the numeral 202. The second AI/ML model may enable multi-purpose of interoperability between, or other compatibility with, the WTRU and the NW. In embodiments, the second AI/ML model is used for data generation when combined with the first AI/ML model. The WTRU may receive the second AI/ML model (architecture and/or parameters) from dedicated signaling (e.g., RRC). In other embodiments, the WTRU may receive the second AI/ML model architecture from broadcast signaling (e.g., SIB) and the model parameters from dedicated signaling (e.g., RRC). Still further, the WTRU may receive second AI/ML model after successful authentication procedure. The WTRU may receive the second AI/ML model in an encrypted channel (e.g., SRBx or DRB). The WTRU may further transmit the identity of the first AI/ML model available at the WTRU and may receive corresponding second AI/ML model from the NW.

As shown in FIG. 2, the WTRU derives a third AI/ML model 212 as a function of first AI/ML model and the second AI/ML model. This functional step 3 is identified by block 204. The WTRU derives a subnetwork from the second AI/ML model, which is used with the first AI/ML model to create the third AI/ML model 212. As an example, the WTRU may be configured with rules to derive or a subnetwork based on a transformation of the second model. The subnetwork may be the whole of second model or, in another example, the subnetwork may be a portion of, such as a few layers, the second model. In embodiments, the subnetwork may be seen as a configuration of parameters for a predefined distribution. The weights of the first few layers of the second AI/ML model may denote the mean and variance of the Gaussian distribution that is input to the first AI/ML model.

The WTRU may be configured with the overloaded encoder from the NW side, i.e. the second AI/ML model. This encoder may be concatenated or otherwise linked with the baseline generative model, such as, the first AI/ML model, to create the WTRU side generative model. In embodiments, the preferred function of the second AI/ML model at the WTRU is to shape a known distribution, e.g., the standard normal distribution, to the input distribution of the first AI/ML model. The WTRU may be configured to derive a subnetwork and a post-processing function from the second AI/ML model. The post-processing steps may include one or more of: post-processing of outputs from the subnetwork, for example, quantization, dimension matching, etc., to make consistent the output of the subnetwork and the input of the first AI/ML model.

As shown in FIG. 2, the WTRU is configured to generate data samples from the third AI/ML model. The input to this third AI/ML model may be samples drawn from a preconfigured distribution. For example, the preconfigured distribution may be standard normal distribution with a configured mean and variance (e.g., 0,1). In a further example, the preconfigured distribution may consist of samples of a random variable from a known and tractable distribution, such as the standard normal distribution, and/or may apply a linear or nonlinear transformation to this standard normal random variable. In a further example, the preconfigured distribution may be realized by a pseudo random sequence generator with a configured initialization parameter.

In embodiments, the WTRU may derive a fourth AI/ML model (e.g., encoder for CSI compression use case) such that one or more preconfigured conditions are satisfied. For example, a performance metric (e.g., normalized mean squared error (NMSE), squared generalized cosine similarity (SGCS) of the fourth AI/ML model may be applied on at least N samples of data generated by the third model exceeds a threshold T (wherein the value of N and T may be configured by the NW or predefined in the standards).

In embodiments, the WTRU may receive data generation configuration e.g., random seed, a second model ID and number of data samples K. The WTRU may generate K channel samples using the third AI/ML model and corresponding K compressed, or otherwise processed, samples using the fourth AI/ML model. In embodiments, the WTRU may transmit the K compressed, or otherwise processed, samples (and optionally the performance metric) to the NW (e.g., during interoperable AI/ML model identification/validation procedure, performance monitoring procedure). Still further, the WTRU may receive model ID/inference configuration/activation of the model.

The proposed approach may be advantageous for the WTRU, both in training the WTRU side model as well as testing/performance monitoring after deployment. These benefits may flow from the dataset sharing. For example, the WTRU side model size deployment, since the WTRU may not be dataset constrained, the WTRU-side autoencoder may be arbitrarily large, accommodating for robust channel compression. Further there may be a reduced overhead storage at the WTRU node created by using generative models. The WTRU may store diverse datasets, may capture different operating conditions, and my increase resource efficiency. These potential advantages may be significant for on-device storage of datasets for neural network (NN) performance monitoring during operation. The dataset sharing may further assist in on-device training. By avoiding the need to store large datasets on device, the WTRU can perform online training or model fine-tuning post deployment.

Another potential advantage may result from large scale performance monitoring at WTRU. By sharing generative models for creating datasets, the WTRU may create an arbitrarily large set of testing samples, that may not be used in model training or fine-tuning, potentially enabling more diverse tests for performance monitoring, with more robust results. The ability to create large test sets in real-time operation may result without the need to store the samples on the device. By not storing samples, there may be an improvement in performance monitoring, an enhanced ability to identify performance bottlenecks, and also maintaining robust CSI compression.

In embodiments, resource efficient performance monitoring may be achieved by avoiding the need to store various large testing datasets for performance monitoring. The WTRU may use different generative models (overloaded encoders) to also monitor performance for other channel scenarios. For example, performance monitoring for mobile users can be more efficient by using different generative models to create testing samples at different WTRU locations. This may enable to the WTRU to monitor performance for previously seen wireless channel conditions, while modifying and fine-tuning the model for new channel conditions, and without the need for storing testing samples for all previously (as discussed in the channel conditions and other scenarios above). Again, this type of operation may lead to improved resource efficiency at the WTRU.

In embodiments, the configuration of the WTRU may include two different AI/ML models, and rules to derive a third AI/ML model (that enables dataset generation) and a fourth model for interoperable CSI compression. As shown in FIG. 2, the first AI/ML model, which may be a generative model, may be configured on the WTRU through broadcast signaling-step 1, 200. Following this, a second AI/ML model is configured on the WTRU using dedicated signaling through an encrypted channel, or after WTRU authentication-step 2, 202. This second AI/ML model is used jointly at the user for both data generation, as well as interoperability. Specifically, the second AI/ML model is used to derive a subnetwork, that is combined with the first AI/ML model to create a third AI/ML model (block 204). This third model 212 may be a data generating model to create channel matrices, represented by the Data Samples in FIG. 2. Further, the second AI/ML model may be used to derive a fourth AI/ML model as a further step, identified by the block 208. As shown, the WTRU side encoder is used for interoperability/compatibility. This fourth AI/ML model may be trained on the Data Samples generated by the third AI/ML model. A local dataset retained or otherwise generated at the WTRU may also be used. For example, the performance of the fourth AI/ML model may be benchmarked using a set of samples generated by the third AI/ML model. The third AI/ML model may be used to locally generate channel samples and then discard these after use. Thus, the third AI/ML model may also further be used for subsequent performance monitoring, dataset similarity testing, etc., without the requirement of storing large datasets on the WTRU.

In embodiments, the configuration of first AI/ML model and second AI/ML model may occur along the lines as follows. A WTRU capable of performing AI/ML based CSI compression using autoencoder (AE) model receives configuration of a first AI/ML model—which may be a generative model (e.g., to generate channel samples), and trained at the NW-side. The WTRU may further receive configuration of a second AI/ML model to operate in conjunction with the configured first AI/ML model and to enable training a WTRU-side AI/ML encoder interoperable with the NW-side AI/ML decoder. The second AI/ML model may be a multi-purpose (e.g., dual-purpose) model enabling interoperability between, or other compatibility with, the WTRU-side encoder and the NW-side decoder, as well as enabling data generation; for example, the second AI/ML model may be an encoder model. The configuration of the first AI/ML model may include structure and parameters of the model. The configuration of the second AI/ML model may include structure and parameters of the model, rules to derive a subnetwork from the second AI/ML model and rules to generate the input to the subnetwork for distribution shaping purposes.

In the embodiment above, the first AI/ML model is a generative model trained at the NW-side (for example, to generate channel samples for different channel conditions). The configuration of the first AI/ML model may include one or more of the following: (1) model structure: for example, the model structure may include the model backbone (e.g., CNN, Transformers), the number of layers, type of each layer (e.g., fully connected, dropout, normalization, number of transformer blocks in case of a Transformer architecture, etc.), activation function, quantization, etc.; and (2) parameters of the model trained at the NW-side. The first AI/ML model may be trained at the NW-side for different scenarios (e.g., channel models corresponding to indoors or outdoors deployment, urban or sub-urban scenarios).

In embodiments, the WTRU may receive configuration for the first AI/ML model structure via broadcast signaling, e.g. via SIB. In another solution, the WTRU may receive an index or an ID of the model structure, for example when one or more structures for the first AI/ML model may be pre-defined. In another solution, the WTRU may receive the first AI/ML model (structure and/or parameters) from a WTRU-side server, for example when the first AI/ML model (structure and/or parameters) is transferred from a NW-side server to a WTRU-side server (for example via non-OTA signaling).

In the embodiment, the second AI/ML model may be an overloaded (i.e., multi-purpose model). The second AI/ML model may serve two purposes: (1) enable interoperability between/compatibility with the WTRU-side encoder and the NW-side decoder and (2) enable data generation for WTRU-side model training. The configuration of the second AI/ML model may include one or more of the following: (a) model type: for example, the second AI/ML model may be the encoder part of the AE, or it may be the decoder part of the AE; (b) model structure, which may include the model backbone (e.g., CNN, Transformers), the number of layers, type of each layer (e.g., fully connected, dropout, normalization, number of transformer blocks in case of a Transformer architecture, etc.), activation function, quantization, etc.; (c) rules to generate the input to the subnetwork for distribution shaping purposes, such as, parameters (scalar or vector) of a probability data function (PDF) (e.g., mean and standard deviation of the normal distribution) and/or an indicator to select from a set of pre-defined distributions, and (d) rules to derive a subnetwork from the second AI/ML model, where the subnetwork is used to shape a data distribution for input to the generative first AI/ML model. The rules to derive a subnetwork include the following. The subnetwork may consist of a set of scaler and/or vector parameters that characterize the preconfigured input distribution of the first AI/ML model. In another example, the subnetwork may consist of the whole model with L_{enc} layers, where the WTRU receives L_{enc} as part of the configuration. In another example, the subnetwork may consist of a subset of layers \hat{L}≤L_{enc} of the second AI/ML model, where the WTRU receives configuration for the number of layers L and an indication to select the first layers, or intermediate layers, or last layers, or not contiguous). In another example, the subnetwork may consist of a low rank adaptation (LoRA) of certain layers of the second AI/ML model.

In embodiments, the WTRU may receive configuration of the second AI/ML model via dedicated signaling, e.g., after authentication. In embodiments, the WTRU may receive the second AI/ML model architecture via broadcast signaling and the model parameters via dedicated signaling. The WTRU may receive configuration of the second AI/ML model in an encrypted channel (e.g. DRB, SRB1/2/3/4 or any bearer with integrity and ciphering protection). The WTRU may further receive configuration for performance validation of the WTRU-trained WTRU-side encoder model, where the configuration may include one or more of the following: (1) performance metrics for WTRU-side encoder model performance evaluation, e.g. SGCS, NMSE, (2) thresholds for the configured performance metrics, (3) number of samples (K) to generate for WTRU-side encoder model validation, (4) reporting configuration for the K data samples (e.g., validation samples) and the corresponding K compressed, or otherwise processed, samples (output of the WTRU-side encoder model), (5) reporting resources for the data samples, (6) optional measurement configuration to collect measurement samples, and (7) data similarity metric—to determine the similarity between generated data samples and measured samples.

Based on the different models shared at the WTRU, (i) the first AI/ML model may be broadcasted to the WTRU or downloaded offline from the NW-side server, and (ii) the second AI/ML model may be configured at the WTRU using dedicated signaling over an encrypted channel. A third AI/ML model may be derived at the WTRU. The example steps involved in setting up and utilizing the third AI/ML model may include: (a) derivation of a subnetwork from the second AI/ML model, (b) combination of the derived subnetwork and the first AI/ML model to create the third AI/ML model, and (c) third model operation using fixed or random inputs to create useful output to the WTRU.

In embodiments, the WTRU derives the subnetwork from the second AI/ML model using a set of specific rules, that are preferably preconfigured at the WTRU, such as the transformation in block 204 in FIG. 2. In embodiments, the subnetwork may consist of the entire second AI/ML model itself. This corresponds to the unity transformation at the WTRU side. In embodiments, the subnetwork may consist of a part of the second AI/ML model. Considering the specific case when the second AI/ML model is the NW-side encoder, a DNN architecture with L_{enc} layers, the subnetwork may utilize the first \hat{L}≤L_{enc} layers of this model. Particularly, the input to the subnetwork has the same dimension as the second AI/ML model, but the output of the subnetwork is an intermediate output (output of a hidden layer) of the second AI/ML model that is tapped and processed further. In a similar manner, the subnetwork may consist of the last \hat{L}≤L_{enc} layers of the second AI/ML model. Additionally, the subnetwork may also consist of an intermediate set of \hat{L}≤L_{enc} layers of the second AI/ML model, that may or may not be a contiguous set of layers.

In embodiments, the subnetwork may additionally consist of a set of scalar and/or vector parameters that characterize a PDF. These parameters are read-off from the second AI/ML model and may be fed to a random number generator to create an output random number that is fed as an input to first AI/ML model. As an example, the first layer of the second AI/ML model may consist of two scalers. The first denotes the mean μ, and the second the standard deviation σ. This is fed to an independent and identically distributed (i.i.d) random number generator to create a vector with each element drawn from N(μ,σ).

In embodiments, low rank adaptation (LoRA) may be applied to one or more preconfigured layers of the second AI/ML model, when deriving the third AI/ML model. This layer may then be tuned, when used to create the third AI/ML model.

As illustrated in FIG. 2, the WTRU may generate, or derive, the third AI/ML model 212 by combining the subnetwork with the first AI/ML model. The first AI/ML model may be configured as a generative model to create data samples using a preconfigured input distribution given by the PDF f_{z}(z). In embodiments, the configured subnetwork may be a set of scalar and/or vector parameters that have been configured on the second AI/ML model. The set of scalar and/or vector parameters may be subsequently fed to a random number generator to create samples from the distribution f_{z}(z).

In embodiments, alternate forms of f_{z}(z) may be possible to generate the samples via shaping of a preconfigured distribution, as discussed below. Further, for intractable distributions (not a closed form of PDF and CDF), the samples may be generated by shaping a preconfigured distribution, as explained below.

In an embodiment, the subnetwork may be concatenated or otherwise linked with the first AI/ML model, with the output of the subnetwork preferably directly fed as input to the first AI/ML model. The input to the subnetwork itself may be a vector consisting of samples drawn from the i.i.d the standard normal distribution [symbol] (0,1). The subnetwork thus converts an input vector w~ [symbol] (0, I_{K}) to an output vector z~f_{z}(z). This establishes the subnetwork as a white noise shaping AI/ML model. In embodiments, the input to the subnetwork w∈ [symbol] ^{K}, may be drawn from any preconfigured input distribution at the WTRU. Thus, the subnetwork may behave as a general distribution shaping function. As an example, the input distribution of the WTRU may be a Laplacian with zero mean and unit variance, which is shaped into the distribution f_{z}(z).

One contemplated advantage of using the subnetwork as a distribution shaping model may be to directly create samples from the input distribution of the first AI/ML model, when the WTRU is configured with only the second AI/ML model. In embodiments, the subnetwork may be trained to generate samples from f_{z}(z) using input as samples drawn from the standard normal distribution, by training the concatenated model in an end-to-end manner. In this example, the WTRU is only configured with the input distribution of the third AI/ML model. The end to end training is further discussed below.

In embodiments, the output of the subnetwork AI/ML model may be passed through a preconfigured transformation operation (linear or nonlinear), before being fed as input to the first AI/ML model. In embodiments, this connection may be an element-wise scalar operation of the output to match the properties of the input preconfigured distribution f f_{z}(z). As an example, the output of the subnetwork may be quantized to b bits and fed into the first AI/ML model. In another example, the output of the subnetwork may be clipped to the range [Mₘᵢₙ, Mₘₐₓ] and input to the first AI/ML model.

The use of an intermediate transformation between the subnetwork output and the input of the first AI/ML model may be a change of dimension. A combination of linear and nonlinear transformations may be used to convert the output of the subnetwork from [symbol] ^{K} to [symbol] ^{K}′. As an example, principal component analysis (PCA) may be applied to the output of the subnetwork to select the top K′ values of the output of the subnetwork. As another example a neural network (NN) architecture, with trainable or preconfigured weights, may be used to convert the output of the subnetwork to the input of the first AI/ML model. In embodiments, a part of the output of the subnetwork (continuous or non-continuous elements) may be fed as input to the first AI/ML model. As an example, if the output of the subnetwork is a vector of dimension K′, the first k′≤K′ values may be taken and fed as input to the first AI/ML model.

In embodiments, additional information may be added via summation, or appended, to the output of the subnetwork to be fed as input to the first AI/ML model. As an example, the input to the first AI/ML model may be a concatenation of the K-dimensional input of the subnetwork and K′-dimensional output of the subnetwork to create an input of dimension K+K′ to the third AI/ML model.

The third AI/ML model, such as 214 shown in FIG. 2, as derived using the combination of the subnetwork and the first AI/ML model may be used as a generative model to create samples of the CSI input. To this end, the input to the third AI/ML model may be a random variable fed from a preconfigured distribution to generate CSI samples. In embodiments, the input samples may be drawn from a preconfigured distribution, with one or both of the analytically known PDF and cumulative distribution function (CDF), or the standard normal distribution. The use of a preconfigured distribution to generate the samples may have several advantages. For example, excessive pre-processing may be avoided in creating input samples, which may increase computational complexity of the third AI/ML model. Further, the amount of information to be configured at WTRU may be reduced in order to create the input samples for the third AI/ML model and, thus may simplify the WTRU configuration. In other examples, the training of the third AI/ML model may be simplified by using standard distributions, e.g., the standard normal distribution. The training of the third AI/ML model as the decoder block of a VAE may be simplified when the standard normal distribution is used as the latent space distribution. Post deployment performance monitoring may be simplified, if the input distribution of the third AI/ML model is a standard preconfigured distribution, e.g., the standard normal distribution. This may reduce the signaling overhead between the NW and WTRU, if the information for data generation must be exchanged from WTRU to NW or vice versa. Also, more complicated and highly parameterized distributions may require more information bits to be exchanged.

In embodiments, the input samples may be created by applying a linear or nonlinear transformation to samples drawn from a preconfigured distribution. For example, the input samples may be created by first drawing samples from a standard normal distribution and then applying a clipping and b-bit quantization operation to each sample. As another example, the input samples may be a K-dimensional vector with i.i.d samples drawn using the CDF of a preconfigured distribution. Specifically, a number may be uniformly chosen between 0 and 1, and the inverse CDF operation may be applied.

In embodiments, the input samples may be generated as an output of a pseudo-random sequence generator. For example, the input samples may be generated as an output of a Markov Chain Monte Carlo method like Gibbs sampling.

For derivation of the fourth AI/ML model as a fourth step, such as block 208 shown in FIG. 2, the WTRU may leverage the third model and/or the second model (e.g., a WTRU-side encoder model). The WTRU may either directly leverage the second model and the third model for training the fourth model or may leverage the output of these models for training. For example, the WTRU may leverage the third model to generate training data for model training. In another example the WTRU may leverage the second model for directly training the fourth model by minimizing the loss between their outputs for the same given input, etc.

In embodiments, such as block 206 in FIG. 2, the WTRU may utilize the second AI/ML model (the shared NW side encoder) to create a WTRU side nominal decoder. As an example, the WTRU may use the second AI/ML model, or apportion thereof, as the WTRU-side nominal encoder. The step/substep is identified as 4A in FIG. 2. The WTRU may utilize the second model and a set of training data points (derived from one or more sources, e.g. WTRU side data, NW side data, generated data, etc.) to train a nominal decoder model to be compatible and operable with the second model. The step/substep is identified as 4B in FIG. 2. The nominal decoder may be trained in an end-to-end manner, similar to how an autoencoder is trained, with the second model serving as an encoder whose weights have been frozen (i.e. not updated) and the nominal decoder serving as the decoder block designed by the WTRU and has updatable or trainable weights. The autoencoder may utilize a loss (e.g., based on mean squared error minimization between the input to the encoder and the output of the decoder) for training the nominal decoder.

Again, as represented by block 206 in FIG. 2, the trained nominal decoder may be utilized to the train the WTRU side encoder model or the fourth AI/ML model. Similar to the training of the nominal model, the WTRU may utilize the nominal decoder model and a set of training data points (derived from one or more sources, e.g., WTRU side data, NW side data, generated data, etc.) to train the WTRU side encoder model (fourth AI/ML model) to be compatible and operable with the nominal decoder model. The fourth AI/ML model may be trained in an end-to-end manner, with the fourth AI/ML model serving as an encoder whose weights have to be updated (trainable weights) and the nominal decoder serving as the decoder block whose weights have been frozen.

In embodiments, the WTRU may directly train the WTRU side encoder model (the fourth AI/ML model) using the NW side encoder model (the second AI/ML model), without training any intermediary nominal model. The WTRU may train the fourth model to minimize the difference between the output of the second model and fourth model for a given input vector.

As also shown in FIG. 2, the WTRU may utilize the third AI/ML model (again, preferably a generative AI/ML model) for training of the nominal model and/or the WTRU side encoder model via the generating of a set of data points (e.g. wireless channel state data) to be utilized for WTRU side model training. The WTRU may choose to utilize only the generated data or some existing WTRU side data or a combination of the two data sources for training the model.

In embodiments, from the training perspective, the WTRU may utilize a relevant loss function (for example, the MSE of the data reconstruction error) to the train the fourth AI/ML model. The WTRU may continue the training until a stopping criterion is met (the number of updates or epochs, loss convergence criterion, etc.). The WTRU may also be configured with additional parameters to enable the training of the fourth AI/ML model (for example, learning rate, rate decay parameters, optimizer details, etc.)

The WTRU may be may also be configured to evaluate and report the performance of the WTRU side encoder model (fourth AI/ML model). The model evaluation, identified as 210 in FIG. 2, may be performed prior to the deployment of the model (post training) or may be evaluated post deployment for performance monitoring. Alternatively or as part of the operation, the WTRU may leverage the third model (the generative model) to generate data and evaluate the performance of the fourth model on this generated data. The WTRU may further be configured with the minimum number of test samples that need to be generated before the performance evaluation may be performed. Additionally, while operating the third model, a certain section of the input seeds (input to the generative model, third model) may be reserved purely for the model evaluation perspective. This may be done to ensure that data used for evaluation is different from the data points generated used the training stage for training the fourth model.

In embodiments, the WTRU may be configured with the testing metric to be evaluated and to be reported. The WTRU may evaluate metrics like the NMSE and SGCS, etc. Further, the WTRU may also be configured with minimum performance thresholds for each of these metrics. The reporting may only be performed if the evaluated metrics fall below the minimum performance threshold.

As illustrated in FIG. 2, the evaluated metrics may further be reported 214 back to the NW. The report may be provided on a per sample basis or holistically using some statistical measures. For example, instead of reporting the SGCS associated with each data sample of the evaluation set, the WTRU may choose to report the mean SGCS and variance of the SGCS across the entire data. The WTRU may further leverage the model evaluation framework to provide both performance feedback and to confirm the interoperability/compatibility with the NW and WTRU side models. For example, the WTRU may report the test or evaluation dataset that was used by the WTRU for calculating the evaluation metrics and as NW to share its own evaluation metrics and compare these values. For interoperability, the value associated with the WTRU side metrics and NW side metrics are preferably close. In embodiments, instead of sharing the evaluation/test dataset, the WTRU may share the input seed used to generate the data and the NW could utilize the same seed to generate the data.

In embodiments, the WTRU-sided model may be applicable with on-demand dataset generation for life cycle monitoring (LCM) architecture. A WTRU may be configured to use overloaded nominal encoder for dual purpose of training a WTRU-sided encoder and generate data for such training. In embodiments, the WTRU may generate dataset using a configured AI/ML model. The WTRU may use the AI/ML model to generate dataset for training WTRU-sided model for interoperability/compatibility. Possibly the AI/ML model to generate data may be a generative AI/ML model. As preferably used herein, the AI/ML model for data generation may be referred to as data generating AI/ML model. For example, the WTRU may determine data generating AI/ML model based on NW configuration. As another example, the WTRU may receive the data generating AI/ML model from the NW. Further, the WTRU may derive the data generating AI/ML model based on a combination of NW configured AI/ML model and a standardized AI/ML model. Possibly the NW configured AI/ML model may be an encoder model. Still further, the WTRU may derive the data generating AI/ML model based on a combination of NW configured AI/ML model and a WTRU sided conditions/configurations. The WTRU may derive the data generating AI/ML model based on one or more methods described above relative to the derivation of the third AI/ML model.

In embodiments, the WTRU may generate data samples based on one or more AI/ML models configured for the WTRU. For example, the WTRU receives one or more AI/ML models from the gNB and/or NW. As another example, the WTRU may use a combination of AI/ML models to generate the data samples. The WTRU may use a combination of AI/ML model received from the gNB and AI/ML model received from OTT server. The WTRU may use a combination of distribution shaping model and a generative model. In another example, the WTRU may use a combination AI/ML model configured by the NW and an AI/ML model predefined in the standards. For example, the WTRU may use a combination of a portion of an AI/ML model received from broadcast signaling and another portion of the AI/ML model being received from a dedicated signaling. In embodiments, the WTRU may receive a portion of the second AI/ML model (e.g., architecture) via broadcast signaling and receive other portions of the model (e.g., parameters) from dedicated signaling or other secure download methods. The WTRU may also receive a portion of the AI/ML model by broadcast signaling in SI message or OTT data. The WTRU may also receive dedicated signaling in RRC message (e.g., reconfiguration, setup etc.), MAC CE (Control Element) etc. The WTRU may generate, or derive, a third model based on the first and second model to create a third model. In embodiments, the WTRU may derive the third model by concatenating the first AI/ML model and second AI/ML model or parts thereof such that the output of the second AI/ML model or parts thereof are fed as inputs to the first AI/ML model. In one or more embodiments, the WTRU may derive the third model by updating a first AI/ML model with one or more parameters from a second AI/ML model.

In embodiments, the WTRU may generate data with AI/ML model wherein the generation process may be based on one or more configuration parameters from the gNB. For example, the data generation configuration may be associated with the first AI/ML model (e.g., a generative AI/ML model). Further, the data generation configuration may be associated with the second AI/ML model (e.g., a shaper AI/ML model, an encoder AI/ML model, a decoder AI/ML model etc.). As another example, the data generation configuration may be based on combination of first AI/ML model and second AI/ML model. In a solution, the data generation configuration may include one or more of the following: a random seed, number of data samples k to be generated, input distribution to the data generation model etc. The WTRU may receive data generation configuration in RRC signaling.

In embodiments, the WTRU may receive plurality of data generation configuration information in a RRC signaling. Each data generation configuration may be associated with specific data generation parameters. The data generation configuration may be associated with specific first AI/ML model. Data generation configuration may further be associated a specific second AI/ML model. For example, the WTRU may receive the data generation configuration information in RRC setup message, RRC reconfiguration message, RRC release message, RRC resume message etc. In a solution, the WTRU may receive indication whether the reception of RRC configuration triggers the data generation process. In another example, the WTRU may receive the data generation configuration information, but the actual trigger to start the data generation process may be based on subsequent signaling. Such subsequent signaling may be in a MAC CE (Control Element).

In embodiments, each data generation configuration in RRC signaling may be associated with a logical ID. The WTRU may receive data generation activation command in a MAC CE. Further the MAC CE may include logical ID of the data generation configuration to be used for data generation. Further, the data generation configuration in the RRC signaling may include a baseline configuration for data generation. The MAC CE activating the data generation may override one or more parameters with a delta signaling.

In embodiments, the WTRU may trigger data set generation when one or more predefined conditions are satisfied. For example, the WTRU may trigger data set generation when the WTRU is triggered to train/fine-tune an AI/ML model. As another example, the WTRU may trigger data set generation when the WTRU downloads a new model. The WTRU may trigger data set generation when the WTRU is configured for performance monitoring. The WTRU may trigger data set generation when the WTRU activates a model for which performance monitoring is not done in the last X seconds. The WTRU may trigger data set generation when the WTRU receives an associated ID for which performance monitoring is not done for the last X seconds. The WTRU may trigger data set generation when the WTRU enters a cell for which performance monitoring is not done for the last X seconds. The value of X may potentially be preconfigured. For example, the WTRU may trigger data set generation when the performance of the AI/ML model goes below a predefined threshold.

Various procedural options may be provided for model identification, pairing, performance monitoring, and validation. In embodiments, the WTRU may receive data generation configuration including but not limited to random seed, input distribution configuration, pre-processing configuration, post processing configuration, the associated model information (first and/or second model identity), number of data samples (K) to be generated. The WTRU may receive the data generation configuration during one or more of: interoperable AI/ML model identification/validation procedure, performance monitoring procedure etc.

In embodiments, the WTRU may derive a data generation model (a third AI/ML model) using the model information, for example, such as the methods for deriving third AI/ML model described above. Upon or more triggers described herein, the WTRU may generate K channel samples using the third AI/ML model. The WTRU compress the K channel samples using the fourth AI/ML model. Examples for deriving the fourth AI/ML model are also described above. The WTRU may additionally derive one or more performance metric (e.g., intermediate KPIs). The WTRU may report the K compressed, or otherwise processed, samples and optionally performance monitoring metrics to the NW. The WTRU may receive model ID/inference configuration/activation of the model, e.g., as a response to the transmission of K compressed, or otherwise processed, samples and optionally performance monitoring metrics.

In embodiments, the WTRU may perform dataset generation procedure to evaluate the dataset similarity between field measurements and the generated samples corresponding to scenarios known apriori. The WTRU may trigger the dataset generation procedure upon a change in associated ID. The WTRU may trigger the dataset generation procedure upon a change in current serving cell. The WTRU may trigger the dataset generation procedure upon a entering a new RAN area. The WTRU may trigger the dataset generation procedure upon a change in WTRU side conditions (e.g., including but not limited to change in WTRU speed, etc.). In embodiments, the WTRU may be configured to perform dataset generation procedure when one or more of conditions being met. For example, the performance of AI/ML model going below a threshold. Other examples may include (i) the HARQ NACK rate goes above a threshold, (ii) when the block error rate (BLER) goes above a threshold, (iii) when a measurement (e.g., RSRP, RSSI, RSRQ, RI, PMI, CQI, SINR, doppler spread, doppler shift, AoA, AoD, delay spread, average delay, position coordinates) goes below or above a threshold, (iv) upon detecting a change in configuration (e.g., BWP configuration, TCI state, LOS/NLOS state, MIMO configuration etc.), (v) upon model switch, upon a model transfer, (vi) upon model update, (viii) upon beam failure, (ix) upon RLF, (x) upon reselection, and/or (xi) upon mobility event. Other parameters and threshold may be defined.

The WTRU may be configured to generate data based on the configured random seed, input distribution, first AI/ML model, second AI/ML model, number of data samples (K), pre/post processing configuration etc. The WTRU may be configured to collect K measurement samples according to received measurement configuration. The K measurement samples may be collected in a preconfigured time interval T1-T2. The WTRU may also be configured to collect K measurement samples such that the time difference between consecutive samples is at least d1 but less than d2. The WTRU may be configured to determine a dataset similarity metric between the generated data samples and measured data samples. For example, the data set similarity distance metric may be one or more of the following: Geometric distances (e.g., pairwise Euclidian, cluster wise Euclidian etc.), statistical distances (e.g., Kullback-Leibler (KL) divergence, Jensen Shannon, Wasserstein, total variation, etc.), and manifold/subspace distances (e.g., Grassmann, Chordal etc.).

In Embodiments, the WTRU may be configured to report the dataset similarity metric to the gNB/NW. For example, the WTRU may report the dataset similarity metric in a dedicated signaling. In another example, the WTRU may report the dataset similarity metric multiplexed with other uplink control signaling. In a solution, the WTRU may report the dataset similarity metric multiplexed with signaling related to model selection/switching/activation. In embodiments, the WTRU may report the dataset similarity metric multiplexed with performance monitoring signaling. Further, the WTRU may transmit dataset similarity in a configured PUCCH resource. For example, such PUCCH resource may be configured periodically or semi-persistently. In another example, such PUCCH resource may be indicated dynamically in a DCI. In a solution, the WTRU may transmit dataset similarity in a MAC CE. In embodiments, the WTRU may be configured to trigger scheduling request (SR) to request resource for transmission of dataset similarity metric. In embodiments, the WTRU may be configured with plurality of SR/PUCCH resource wherein each SR resource may be associated with a dataset similarity metric range. For example, a first PUCCH resource preconfigured to indicate a low dataset similarity, a second PUCCH resource to indicate a medium dataset similarity and a third PUCCH resource to indicate high dataset similarity. The WTRU may implicitly indicate the dataset similarity metric by selection and transmission of SR on the preconfigured resource. For example, if the dataset similarity metric goes below a threshold configured for low dataset similarity, the WTRU may transmit SR on the first PUCCH resource to implicitly indicate the dataset similarity.

In embodiments, the WTRU may transmit the dataset similarity metric in a RRC message. For example, the WTRU may receive configuration for dataset similarity metric in RRC reconfiguration. In embodiments, the WTRU may transmit the dataset similarity metric in RRC reconfiguration complete. Further, the WTRU may transmit the dataset similarity metric in a WTRU Assistance Information. The WTRU may receive dataset similarity metric configuration in a WTRU information request. In embodiments, the WTRU may transmit the dataset similarity metric in WTRU information response.

The WTRU may be configured to report the generated data samples or dataset similarity metric to the NW, based on a condition associated with the dataset similarity. In a solution, the WTRU may transmit a statistic (min, max, average, standard deviation etc.) associated with data samples. In embodiments, the WTRU may transmit a low dimensional transformation of the data samples. The WTRU may transmit a low processed/quantized/compressed version of the data samples. For example, the WTRU may transmit the data samples when the dataset similarity between generated data samples and the measured data samples. In another example, the WTRU may transmit the data samples when the dataset similarity between generated data samples and the measured data samples. The WTRU may be configured to transmit one of more of: dataset similarity metric, generated data samples, measured samples, model ID, model selection/switching information, any WTRU side condition (e.g., RSRP, RSSI, RSRQ, RI, PMI, CQI, SINR, doppler spread, doppler shift, AoA, AoD, delay spread, average delay, position coordinates etc.), periodically, semi-persistently or aperiodically based on events and/or based on NW request.

In the embodiments described herein, the NW may be configured with the metrics for training and/or validation of the first and second AI/ML models. This may include, but is not limited to, the size of the test set for evaluating the trained models, and the minimum or maximum allowable metrics on the loss function, both for CSI compression and dataset generation. As an example, the NW may be configured with the maximum NMSE required for deriving the second AI/ML model for CSI compression. Alternatively, the NW may be configured with a minimum SGCS required for CSI reconstruction. Additionally, the NW may be configured with the maximum allowable generative model loss for the dataset generation from the second AI/ML model.

In embodiments, the NW may choose a distribution for the input to the first AI/ML model, f_{z}(z). As an example, the NW may choose a preconfigured input distribution, e.g., the Gaussian distribution with arbitrarily chosen mean and variance parameters. As another example, the NW may choose the output of a preconfigured pseudo-random number generator as input to the first AI/ML model. Still further, the input samples may be created by applying a linear or nonlinear transformation to samples drawn from a preconfigured distribution. As an example, the input samples may be created by first drawing samples from a standard normal distribution and then applying a clipping and b-bit quantization operation to each sample.

In embodiments, the NW may configure the first AI/ML model for multiple datasets. As an example, the NW may construct several datasets corresponding to different NW-side additional conditions. These are denoted by

$${𝒟}_{H , NW}^{( 1 )} , {𝒟}_{H , NW}^{( 2 )} , … , {𝒟}_{H , NW}^{( N )} ,$$

corresponding to each of these datasets, distributions are configured as

$${ff}_{z}^{( 1 )} ( z ) , {f}_{z}^{( 2 )} ( z ) , … , {f}_{z}^{( N )} ( z ) .$$

The first AI/ML model if subsequently trained to map a random variable from distribution

$${f}_{z}^{i} ( z )$$

to the dataset

$${𝒟}_{H , NW}^{( i )} .$$

In embodiments, the NW may configure a set of multiple second AI/ML models. As an example, for the case where the NW configures the first AI/ML model to generate samples from different datasets, based on input from different distributions, the NW may configure multiple second AI/ML models. Each of the second AI/ML models configured may be trained to uniquely shape a preconfigured distribution like the standard normal distribution to the input distribution, i.e., mapping distribution

$${f}_{z}^{i} ( z )$$

to a dataset

$${𝒟}_{H , NW}^{( i )} .$$

The configuration of the first AI/ML model may be a generative model for training or performance evaluation, or both, of the interoperable model. In this configuration, the following steps may be performed by the NW with regards to the first AI/ML model. In embodiments, the parameters of generating the samples of interest for the interoperable model training are configured at the NW. In embodiments, the first AI/ML model may be configured to generate samples with the same statistics as a preconfigured dataset. As an example, the NW may configure the first AI/ML model to generate CSI matrices with similar properties as a preconfigured dataset of CSI matrices got from field measurements. As another example, the generative model may be configured to generate CSI samples with similar properties as a preconfigured dataset of simulated channel matrices. This preconfigured dataset may be generated using standard model like the clustered delay line (CDL) model.

As another example, the preconfigured dataset may consist of a mixture of samples from both field measurements and simulated data. In embodiments, the first AI/ML model may be configured to generate samples from a standardized dataset. As an example, the first AI/ML model may be configured to generate samples from a standard statistical model like the Rayleigh fading channel. As another example, the first AI/ML model may be configured to generate samples from a standard library of stored channel matrices.

In embodiments, the first AI/ML model may be configured to generate samples for the WTRU-side dataset. As an example, the WTRU may configure a training dataset (either data samples or data creation parameters), which may be used to configure the first AI/ML model.

The first AI/ML model may be configured to generate samples from a distribution of random variables. The input distribution f_{z}(z) is configured to generate samples from the first AI/ML model. In embodiments, the input samples may be drawn from a preconfigured distribution, with analytically known PDF or CDF, or both, e.g., the standard normal distribution. In embodiments, the input samples may be created by applying a linear or nonlinear transformation to samples drawn from a preconfigured distribution. For example, the input samples may be creating by first drawing samples from a standard normal distribution and then applying a clipping and b-bit quantization operation to each sample. As another e.g., the input samples may be a K dimensional vector with i.i.d samples drawn using the CDF of a preconfigured distribution. Specifically, a number is uniformly chosen between 0 and 1, and the inverse CDF operation is applied. In embodiments, the input samples may be generated as an output of a pseudo-random sequence generator. For example, the input samples may be generated as an output of a Markov Chain Monte Carlo method like Gibbs sampling.

Once the first AI/ML model has been configured at the NW, it may be broadcast to the WTRU. In embodiments, the NW may broadcast the first AI/ML model using a broadcast signal like SIB. As an example, the NW broadcasts the model architecture as well as parameters for the first AI/ML model to the WTRU. In another example, the NW may use a standardized model architecture, e.g., ResNet18, and broadcasts the parameters of this model to the WTRU. In embodiments, the NW may upload the server on a NW side OTT server, to be downloaded at the WTRU side. As an example, the NW uploads the first AI/ML model on a NW-side webpage. This is downloaded at the WTRU side server. As another example, the NW uses a standardized model architecture, e.g., ResNet18, for the first AI/ML model and uploads the specific parameters of this first AI/ML model on a NW-side OTT server. In embodiments, the NW may use a pretrained standardized model as the first AI/ML model and broadcast the model ID and details to the WTRU. Alternatively, the ID of the standardized model may be uploaded on a NW side OTT server.

An advantage from broadcasting the first AI/ML model to the WTRU may be in avoiding the overhead in transmitting multiple NWs during signaling with between the NW and the WTRU. As an example, the first AI/ML model may be larger than the second AI/ML model, since it is configured as a generative model and the second AI/ML model is configured to derive a subnetwork for noise shaping, that may be a simpler model than the first AI/ML model. By broadcasting the first AI/ML model, the overhead of transmission to the WTRU is reduced.

The second AI/ML model is derived at the NW for the dual purpose of interoperable CSI processing (for example CSI compression) and dataset generation. In embodiments, in deriving the model function for interoperable CSI compression, the second AI/ML model may be configured as a part of the CSI compression model at the NW. As an example, the second AI/ML model may be the encoder for the end-to-end trained autoencoder derived at the NW for CSI compression. In another example, the second AI/ML model may be the decoder for the end-to-end trained autoencoder derived at the NW for CSI compression. In a further example, the second AI/ML model may be a part of the autoencoder for the CSI compression, comprising of overlapping parameters from the encoder and decoder. In embodiments, the second AI/ML model may be configured as a part of a standardized AI/ML model. This model may be fine-tuned for CSI compression using the NW-side conditions. As an example, the second AI/ML model may be the encoder of a pretrained standardized autoencoder.

The second AI/ML model may also be configured to enable the creation of a model that can be used for dataset generation. In embodiments, the same model used for interoperable CSI compression may be derived for dataset generation. As an example, the second AI/ML model may be initially derived as the encoder for the CSI compression model. This type encoder may also be derived as a model which is concatenated with the first AI/ML model, to create a NW for dataset generation. In embodiments, the second AI/ML model may be configured with a set of scalar or vector parameters that can be used to create the input for the first AI/ML model. As an example, the first AI/ML model may be configured with a Gaussian distribution. The mean and variance of this distribution may be appended as a layer to the encoder of the CSI model to create the second AI/ML model, that is transmitted to the WTRU over an encrypted channel.

In embodiments, the second AI/ML model is passed through a series of transformations to create a model that may be used for dataset generation, when used with the first AI/ML model. As an example, an input vector is reshaped before being input to the second AI/ML model using a linear transformation like a matrix multiplication.

As discussed above, the second AI/ML model may be derived at the NW for joint functionality of CSI compression and dataset generation. The joint derivation of the two functionalities may be realized at the NW using various methods. In embodiments, the CSI compression functionality of the second AI/ML model may be derived before adding the dataset generation functionality to the second AI/ML model. In a similar manner, the dataset functionality may be derived before the CSI compression. As an example, the second AI/ML model may first be derived as an encoder for interoperable CSI compression. Following convergence, the second AI/ML model may then be used for noise shaping, to convert a preconfigured distribution like the standard normal distribution to the input distribution of the first AI/ML model, i.e., f_{z}(z). In embodiments, the CSI compression functionality and dataset generation functionality may be jointly derived. As an example, the second AI/ML model may be trained to jointly optimize the loss function for CSI compression and dataset creation. One of the methods for joint optimization may be the use of alternating optimization. Specifically, we first train the second AI/ML model is trained on the autoencoder reconstruction loss t₁ epochs, and then the updated model is trained on the generative model loss for t₂ epochs, which is used to again train the second AI/ML model for t₁ epochs on the autoencoder reconstruction loss, and so on. This may be performed till convergence of both losses or till a threshold number of iterations.

As a method of operation by a WTRU or the processor configuration may include the following steps or elements. The WTRU receives from a NW a first AI/ML model, preferably by a broadcast signaling process. The WTRU receives from the NW a second AI/ML model by dedicated signaling or other secure download procedure. In embodiments, a portion of the second AI/ML model may be received by broadcast signaling. Further, the WTRU may send the identity of the received first AI model to the NW, and the NW may respond with a second AI/ML model that corresponds to the first AI/ML model.

The WTRU uses the first and second models to generate a third AI/ML model. The WTRU further receives from the NW a data generation configuration, which may be part of a separate message, a pre-configuration or included in the receipt of the first and/or second models. On the WTRU side, data samples are generated using the third AI/ML model based on the data generation configuration. Further, the WTRU will report to the NW, including an interoperability report based on the plurality of data samples generated using the third AI/ML model and an output of a fourth AI/ML model within the WTRU.

In embodiments, the fourth AI/ML model may be generated using one or more of the second AI/ML model, the third AI/ML model, data from the second AI/ML model and data generated by the third AI/ML model. The output of the fourth AI/ML model may be a compressed, or otherwise processed, version of the plurality of data samples generated using the third AI/ML model. The fourth AI/ML model may also generate data for an AI/ML use case, such as CSI compression. In embodiments, the fourth AI/ML model, based on the second AI/ML model, may generate data based on a performance metric and the plurality of data samples generated using the third AI/ML model. In this regard, the performance metric is one or more of normalized mean squared error (NMSE) and squared generalized cosine similarity (SGCS). The output of the fourth AI/ML model or the performance metric associated with the fourth AI/ML model may include data samples and may be reported to the NW.

Preferably, the first model is a generative AI/ML model. The first AI/ML model may be configured to generate samples of channel matrices from a predefined channel distribution, wherein the distribution may include one or more of a predefined statistics, current measurements, and synthetic data. In embodiments, the second AI/ML model may be received via an RRC message. The second AI/ML model may include an encoder model or a decoder model. In embodiments, the second AI/ML model may be configured to determine interoperability between, or other compatibility with, a model operating at the WTRU and a model operating at the NW. The second AI/ML model may be configured to generate data samples to be sent to the NW to assist in evaluating interoperability between, or other compatibility with, the NW side models and the WTRU sided models.

The WTRU may generate a subnetwork using the second AI/ML model and generate, or derive, the third AI/ML model using the first AI model and the generated subnetwork. The subnetwork in this regard may be used as key to open the desired elements of the first AI/ML model, which becomes the third AI/ML model. The subnetwork may include a subset of the layers of the second AI/ML model and may define parameters associated with a distribution configuration associated with the first AI/ML model).

The third AI/ML model may generate the plurality of data samples using a set of data samples determined from one or more of preconfigured distribution, current field measurements and historical measurement data. The preconfigured distribution is a standard normal distribution with a configured mean and variance, may include samples of a random variable, or may be based on a pseudo random sequence generator that uses an initialization parameter configured by the NW. In embodiments, the data generation configuration may include one or more of a random seed, a combination of an identity of the second AI/ML model and a number of data samples. The data generation configuration may also include a post processing network derived from the second AI/ML model.

The WTRU may receive preconfigured distribution form the NW including one or both of a standard normal distribution with a configured mean and variance and samples of a random variable from a known and tractable distribution. Further, in embodiments, the preconfigured distribution comprising a pseudo random sequence generator with a configured initialization parameter.

The processes, configurations and instrumentalities described herein may apply in any combination, may apply to other wired or wireless technologies, for other services and in other forms.

We claim:

1. A wireless transmit/receive unit (WTRU) comprising:
a processor configured to:
receive, from a network, a first artificial intelligence or machine learning (AI/ML) model via broadcast signaling;
receive, from the network, a second AI/ML model via dedicated signaling;
generate a third AI/ML model using the first AI/ML model and the second AI/ML model;
receive a data generation configuration;
generate a plurality of data samples using the third AI/ML model based on the data generation configuration;
send an interoperability report to the network, wherein the interoperability report is based on the plurality of data samples generated using the third AI/ML model and an output of a fourth AI/ML model.

2. The WTRU of claim 1, wherein the fourth AI/ML model is generated using one or more of the second AI/ML model, the third AI/ML model and data from the third AI/ML model.

3. The WTRU of claim 2, wherein the second AI/ML model is configured to generate the fourth AI/ML model that is compatible with an AI/ML model operating at the network, and wherein the second AI/ML model is configured to generate data samples when combined with the first AI/ML model.

4. The WTRU of claim 2, wherein the processor is configured to generate the fourth AI/ML model using data generated by the third AI/ML model, and wherein the output of the fourth AI/ML model comprises a compressed version of the plurality of data samples generated using the third AI/ML model.

5. The WTRU of claim 1, wherein the processor is configured to send one or more of the output of the fourth AI/ML model and a performance metric associated with the fourth AI/ML model.

6. The WTRU of claim 1, wherein the first AI/ML model is configured to generate samples of channel matrices from a predefined channel distribution, wherein the distribution comprises one or more of a predefined statistics, field measurements, and synthetic data.

7. The WTRU of claim 1, wherein the processor is configured to:
generate a subnetwork using the second AI/ML model; and
derive the third AI/ML model using the first AI model and the subnetwork generated using the second AI/ML model.

8. The WTRU of claim 7, wherein the subnetwork comprises one or both of at least a portion of layers of the second AI/ML model and parameters associated with a distribution configuration associated with the first AI/ML model.

9. The WTRU of claim 1, wherein the processor is configured to:
generate the plurality of data samples using the third AI/ML model based on a set of data samples determined from one or more of a preconfigured distribution, current measurements, and historical measurement data.

10. The WTRU of claim 1, wherein the first AI/ML model is a generative model.

11. A method performed by a wireless transmit/receive unit (WTRU) comprising:
receiving, from a network, a first artificial intelligence or machine learning (AI/ML) model via broadcast signaling;
receiving, from the network, a second AI/ML model via dedicated signaling;
generating a third AI/ML model using the first AI/ML model and the second AI/ML model;
receiving a data generation configuration;
generating a plurality of data samples using the third AI/ML model based on the data generation configuration;
sending an interoperability report to the network, wherein the interoperability report is based on the plurality of data samples generated using the third AI/ML model and an output of a fourth AI/ML model.

12. The method of claim 11, wherein the fourth AI/ML model is generated using one or more of the second AI/ML model, the third AI/ML model and data from the third AI/ML model.

13. The method of claim 11, further comprising generating the fourth AI/ML model using the second AI/ML model, and wherein the second AI/ML model is configured to generate the fourth AI/ML model that is compatible with an AI/ML model operating at the network, and wherein the second AI/ML model is configured to generate data samples.

14. The method of claim 11, wherein the output of the fourth AI/ML model comprises a compressed version of the plurality of data samples generated using the third AI/ML model.

15. The method of claim 11, wherein the first AI/ML model is a generative model.

16. The method of claim 11, further comprising
generating a subnetwork using the second AI/ML model, wherein the subnet at least a portion of layers of the second AI/ML model and defines parameters associated with a distribution configuration associated with the first AI/ML model; and
generating the third AI/ML model using the first AI model and the subnetwork generated using the second AI/ML model.

17. The method of claim 11, wherein the processor is configured to:
generate the plurality of data samples using the third AI/ML model based on a set of data samples determined from one or more of a preconfigured distribution, current measurements, and historical measurement data.

18. A wireless transmit/receive unit (WTRU) comprising:
a processor configured to:
receive, from a network, a first artificial intelligence or machine learning (AI/ML) model via broadcast signaling, wherein the first AI/ML model is a generative model;
receive a second AI/ML model via dedicated signaling;
generate a third AI/ML model using the first AI/ML model and the second AI/ML model;
generate a plurality of data samples using the third AI/ML model based on a data generation configuration;
generate a fourth AI/ML model using one or more of the second AI/ML model, the third AI/ML model and data from the third AI/ML model, wherein the wherein the fourth AI/ML model is compatible with an AI/ML model operating at the network;
send an interoperability report to the network, wherein the interoperability report is based on the plurality of data samples generated using the third AI/ML model and an output of the fourth AI/ML model.

19. The WTRU of claim 18, wherein the processor is configured to:
generate a subnetwork using the second AI/ML model; and
generate the third AI/ML model using the first AI model and the subnetwork generated using the second AI/ML model.

20. The WTRU of claim 19, wherein the subnetwork comprises one or both of at least a portion of the layers of the second AI/ML model and parameters associated with a distribution configuration associated with the first AI/ML model.
